(19) United States
(12) Patent Application Publication
(10) Pub. No.: US 2006/0230044 A1
(43) Pub. Date: Oct. 12, 2006

(54) Records management federation

(76) Inventor: Tom Utiger, Las Vegas, NV (US)

Correspondence Address: DECHERT LLP, P.O. BOX 10004, PALO ALTO, CA, 94303, US

(21) Appl. No.: 11/100,890

(22) Filed: Apr. 6, 2005

(51) Int. Cl. G06F 17/30

(52) U.S. Cl. 707/10

(57) ABSTRACT

A record management system includes: a configuration repository providing a mapping between object information and record management information for each of a plurality of record management actions; at least one object side record management module communicatively coupled with an ECI tool, an ILM engine and the configuration repository, and being responsive to object events, and operative to initiate and control at least one of the record management actions based on the mapping provided by the configuration repository; and at least one record side record management module communicatively coupled with the ILM engine and the configuration repository, and being responsive to record events, and operative to initiate and control at least one of the record management actions based on the mapping provided by the configuration repository.

### FIELD OF THE INVENTION

The present invention relates generally to records and document management. More specifically, the present invention relates to a system and method for applying records control functions including identification, classification, management, and disposition of records related to various document management systems or repositories.

### DESCRIPTION OF THE RELATED ART

Records management has been practiced since humans first began transacting business. For example, in certain ancient cultures, clay tablets were used to document transactions involving land and livestock. Sometimes the tablets were wrapped in an envelope of baked clay, and then stored in a local temple. In the event of a dispute, a neutral third party (e.g., a priest or priestess) could break the authenticating envelope and verify the original transaction. These ancient practices demonstrate the importance of managing records properly so that they can be accessed and authenticated in the event of a legal dispute. Of course, the management of records has become far more complex in the modern world. First of all, records are no longer limited to tangible form such as paper, but now include many different forms of electronic data. Second, business transactions in the modern worlds are very complex and often involve hundreds of people working on a single transaction. In addition, the modern legal system demands that records be managed according to very particular policies governed by various regulatory agencies. As a result of these increasingly complex demands, records management is now an incredibly difficult challenge for even the largest and most sophisticated corporations.

Records management was a staid but well developed practice until the relatively recent proliferation of electronic systems and electronic documents. Records managers have struggled over the past few decades to manage more and more different types of electronic records in an increasingly wide variety of different business contexts. Just like a paper record, electronic records must be managed in a way that protects the integrity and authenticity of the record. Currently, there is a wide gap between the legal requirements for record authenticity and technological advances in the computer industry. Unfortunately, the development of computer systems and electronic records has outpaced the development of records management systems.

Records management systems developed over past few decades generally fall into one of four distinct generations. Each generation provides solutions to different problems, but leaves a variety of other problems unsolved. First generation records management software systems were developed in the 1970s to manage physical assets such as inventory, boxes, folders, files and microfilm. These types of systems, which are still to some extent, allow companies to track and identify records that need to be dispositioned. While the early versions of the first generation systems were simple and unsophisticated databases, modern versions have become highly specialized and provide a wider set of features for managing physical records. However, these systems do not interact with electronic document repositories. Recent regulatory changes changed the focus of records management from physical records to electronic records.

Second generation records management systems, first introduced in the 1980's, allow for management of specialized repositories of electronic records. Many features have been added to these products since their first introduction, and they remain prevalent in today's market. But, there are a number of problems with these second generation systems. The first and foremost is that they are only operative to manage records in a single repository. Using such systems, the only records under control are those that have been placed into the single repository. Companies using second generation records management systems therefore have many different systems managing different repositories which do not integrate. Another problem with the second generation systems is that the records management repositories are not optimized for general purpose document management. Instead, they are customized for accomplishing very particular records management processes. So in order to manage a document using a second generation system, the document must be moved out of the business production business process into the records repository. Copy control problems arise where a document is copied from one repository to another, leading to the existence of multiple copies. Copy control problems of this nature can spiral out of control in large organizations that manage millions of documents. Most large organizations use many different electronic applications that generate and store electronic documents, including email systems, websites, file servers, document management systems, records management systems, accounting systems, and enterprise resource planning systems. Often, documents are moved and copied between these systems without regard to how many copies should exist and where they should be stored. As organizations grow, they invariably acquire more different types of systems generating more and more different types of documents, leading to greater problems.

Another problem with second generation systems is that lifecycle management functions are very limited. The term “lifecycle management” refers generally to policies, processes, practices, or tools used to manage records up to the time that the records are finally dispositioned. Lifecycle management has become particularly important following public concerns about corporate ethics that have led to government regulations (e.g., the Sarbanes-Oxley act) dictating that certain types of corporate records be managed according to various rules. Many corporations are currently struggling with the challenge of instituting policies for retaining and disposing of records in a manner that is in compliance with government regulations. Also, corporations are often faced with the problem of having to produce documents in response to court orders in the context of legal disputes. Ideally, the lifecycle management of a record would begin when the document is created or received. Using second generation systems, a document generally cannot be placed under lifecycle control until after all business processing has been completed. The execution of litigation holds and other lifecycle events often cannot wait until the end of business processing and official declaration of a document as a record. This has created great strife in organizations as they have interacted with the courts and regulators.

Third generation records management systems, first introduced in the late 1990s, provide for management of vendor aligned repositories (i.e., repositories configured and manufactured in accordance with specifications of particular vendors). These systems were developed to address customer demands for a single common records management point of control. Early versions of the third generation systems used a vendor aligned repository method. In accordance with this method, a vendor provides a single records management tool that controls all of that vendor's products. This was a radical step forward in that you could now apply a uniform records management policy set to more than a single electronic document system. However, third generation systems inherited all of the failings of the previous generations where an organization uses products provided by different vendors.

The most glaring problem associated with third generation systems is that most organizations own document repositories provided by multiple vendors. This leads to customers having to reorganize and consolidate a variety of internal systems. Such reorganization is very expensive in terms of time and lost profits. Thus, third generation vendor aligned systems do not provide an adequate solution to the problems associated with using multiple records management systems. For all but the smallest company there is still the problem that an organization must have more than one records management system to address the various content repositories or risk leaving them unmanaged.

Fourth generation record management systems, which were introduced in the early 2000s, utilize information lifecycle management (“ILM”) engines in taking a vendor neutral approach to management of document repositories. One example of a fourth generation record management system is the Tarian e-Records Engine provided by IBM Corporation. In general, fourth generation systems are not limited to managing a specific document repository. Instead, they utilize software connectors to access and manage different types of document repositories. Fourth generation systems apply records controls functions and policies across different types of repositories by communicating via these software connectors. Fourth generation systems also offer the ability to track the movement of document between repositories as the documents moves through a business process. However, there are still a number of limitations associated with these systems. The first problem is that of tracking only declared records. In fourth generation systems, only those documents registered with the ILM engine are managed, while all of the other objects within an organization are effectively invisible. Thus, when a corporation receives a court order to produce certain requested documents, problems arise when the requested documents have not been declared to be records. It is relatively easy to identify the records already registered, but those, not in the system, are difficult to find. Another related problem is that such systems cannot search across both records and non-records. Without a common search interface operative to search all types of content repositories and both records and non-records, there will be gaps in how records are processed in the organization.

One of the biggest challenges that exists within the world of records management is how to search across all of the content within an organization whether or not it is a record. When a discovery request is issued to a company (e.g., in accordance with a court order), the requesting party does not care if the documents they are requesting are declared as “official” records (i.e., records managed by a records management team) or if they are an unmanaged documents. This creates a burden on the records management team to search across multiple locations within the organization to find the required documents. Companies spend huge amounts of money trying to address this issue.

Another problem involves records spoliation which takes place in the regular course of business. In these systems this improper destruction is not actively tracked and processed. None of the previous generations of records management software packages offer any kind of method for identifying when spoliation has occurred.

Yet another problem is that organizations are now applying records management to non-traditional content repositories that have never required records controls and were never designed to be controlled. These non-traditional repositories include instant messaging, websites, enterprise resource planning, email, email archives, and relational databases. Previous generations of records management systems have focused only on managing objects that have place in a content repository that is “easy” to manage rather than deal with the vagaries of real world records management.

Most corporations are faced with the task of managing different types of records stored in different types of repositories. Specific tools are needed to administer and monitor policies across these various repositories to ensure the proper retention and disposition of regulated records. Thus, there is a need for a federated, uniform method for applying records controls across all records regardless of where they are stored, physically or electronically. The present invention allows for management of records, which are stored in multiple different repositories and which have been created by multiple different applications.

### BRIEF SUMMARY OF THE INVENTION

The present invention provides a record management system for managing records corresponding with objects stored in a plurality of content repositories each being communicatively coupled with an enterprise content integration (“ECI”) tool operative access the content repositories in order to perform object management functions, and an information lifecycle management (“ILM”) engine operative to store and manipulate the records. The object management functions performed by the ECI tool may include: searching for objects, adding objects, modifying objects, deleting objects, changing security attributes associated with objects, and updating metadata associated with objects. In a preferred embodiment of the present invention, each of the content repositories has a different native application programming interface (“API's”), and the ECI tool is operative to transform the native API's of each of the content repositories into a uniform API.

The record management system of the present invention includes: a configuration repository providing a mapping between object information and record management information for each of a plurality of record management actions; at least one object side record management module communicatively coupled with the ECI tool, the ILM engine and the configuration repository, and being responsive to object events, and operative to initiate and control at least one of the record management actions based on the mapping provided by the configuration repository; and at least one record side record management module communicatively coupled with the ILM engine and the configuration repository, and being responsive to record events, and operative to initiate and control at least one of the record management actions based on the mapping provided by the configuration repository.

In varying embodiments of the present invention, the object information may include: document class information identifying the document class of an object involved in a corresponding management action; and content repository identification information identifying which if the content repositories should be accessed in connection with a corresponding record management action. In one embodiment, the record management information includes record management action information indicating how to perform record management actions against the objects stored in the different content repositories. The record management actions may include: registering records for selected objects; transitioning lifecycle phases for selected records; dispositioning selected records; updating metadata associated with selected records; and updating security associated with selected records.

In varying embodiments of the present invention, the record management information may include: meta-data mapping information providing a mapping between document classes and record classes for a corresponding record management action; file plan classification information indicating where in the file plan a record should be inserted; and record class information indicating a type of record and record attributes.

In one embodiment, the object side record management module comprises a record registration module operative to perform a record registration process, and the object events include the detection of a new unregistered object to be registered in accordance with the record registration process. In another embodiment, the object side record management module is a legal hold module operative to perform a legal hold process, and the object events include the identification of one or more objects to be placed on legal hold in accordance with the legal hold process. In a further embodiment, the object side record management module is a spoliation detection module operative to perform a spoliation detection process, and the object events include the identification of one or more objects that have been destroyed.

In accordance with one aspect of the present invention, the record side record management module is a lifecycle transition module operative to perform a lifecycle transition process, and the record events include the identification of one or more records which have been identified for a change in lifecycle.

In accordance with one aspect of the present invention, each of the registered objects has an associated lifecycle managed by the ILM engine, and the record management actions include transitioning the lifecycle of selected registered objects. In an embodiment, the ECI tool includes a file plan, wherein records are inserted into corresponding locations in the file plan, and wherein the location of each record in the file plan dictates at least in part the lifecycle of the corresponding registered object.

In one embodiment of the present invention, the record management module is a record registration module operative to perform the steps of: identifying an object to be registered as a new record; retrieving record configuration information from the configuration repository in order to configure the new record; determining a record class indicating a location for the new record in a file plan in the ILM engine; retrieving classification method information indicating a method for location the new record in the file plan; creating record metadata using metadata mapping information; and inserting the new record into the determined location in file plan in the ILM engine. The record registration module may also be operative to perform the further steps of: updating metadata associated with the object; changing security attributes associated with the object; creating renditions; and creating digital signatures.

In another embodiment of the present invention, the record management module is a spoliation detection module operative to perform the steps of: identifying an object that has been destroyed; retrieving record configuration information associated with the identified object from the configuration repository; and updating the ILM engine to include audit information indicating that the identified object has been destroyed.

The record management modules may also include a legal hold module operative to perform the steps of: selecting a hold; identifying at least one content repository containing an identified object requiring a hold; determining whether or not the identified content repository is enabled to provide a legal hold; determining whether or not the identified object is registered in the ILM engine; and if the content repository is enabled and the identified object is registered, adding the record corresponding with the identified object to the hold. If the identified object is not registered, the legal hold module may register the identified object as a record before adding the corresponding record to the hold. If the content repository is not enabled to provide a legal hold, the legal hold module may extract the identified object from the identified content repository; insert the identified object into a different content repository that is enabled to provide a legal hold; register the object with the ILM; and place the object into the legal hold.

In yet another embodiment of the present invention, the record management module is a lifecycle transition module operative to perform the steps of: identifying at least one record associated with an object selected for a change in lifecycle; retrieving record configuration information associated with the identified record from the configuration repository; and performing at least one lifecycle transition action based on the record configuration information associated with the identified record.

### BRIEF DESCRIPTION OF THE DRAWINGS

These and other features, aspects and advantages of the present invention will become better understood with regard to the following description, appended claims, and accompanying drawings where:

FIG. 1 is schematic block diagram illustrating a records management system in accordance with one embodiment of the present invention for managing objects stored in a plurality of different types of content repositories, the system including an enterprise content integration (“ECI”) tool, an information lifecycle management (“ILM”) engine, a plurality of configuration repositories, a lifecycle event handler, and a plurality of record management modules;

FIGS. 2A and 2B show schematic block diagrams generally illustrating details of some exemplary object side management modules including a record registration module and an object spoliation module in accordance with one embodiment of the present invention;

FIG. 3 shows a block diagram generally illustrating record management mapping information stored in the configuration repository of FIG. 1;

FIG. 4 shows a flow chart generally illustrating a record registration process for registering objects with the ILM engine;

FIG. 5 shows a flow chart generally illustrating a records spoliation detection process in accordance with the present invention.

FIG. 6 shows a flow chart generally illustrating a legal hold process in accordance with the present invention; and

FIG. 7 shows a flow chart generally illustrating a record lifecycle transition process in accordance with the present invention.

### DETAILED DESCRIPTION OF THE INVENTION

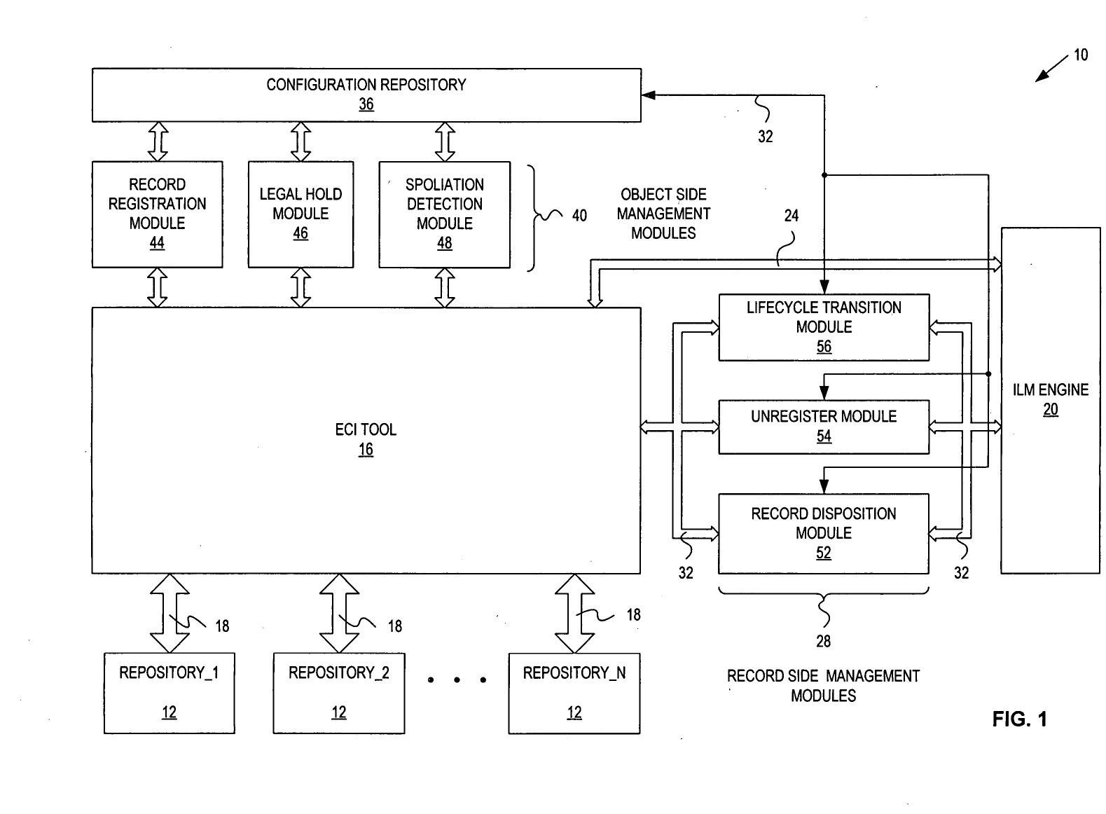

FIG. 1 shows a schematic block diagram illustrating a records management system at 10 in accordance with one embodiment of the present invention for managing objects stored in a plurality of N different types of content repositories 12 designated REPOSITORY_1, REPOSITORY_2 . . . REPOSITORY_N, where N is any integer number. In one embodiment, each of the content repositories 12 may be provided by a different vendor. As such, each of the content repositories may have a different native application programming interface (“API”). The content repositories may be implemented by commercially available systems such as IBM Content Manager™, Open Text Livelink™, Documentum™, FileNet™ Content Services, Hummingbird DM5™, SAP™, PeopleSoft™, Microsoft Exchange™, or Lotus Domino™. As explained below, the records management system 10 provides a uniform method for applying records control functions to objects stored in all of the content repositories 12.

The system 10 includes: an enterprise content integration (“ECI”) tool 16 communicatively coupled with the repositories 12 via a plurality of repository connectors 18; an information lifecycle management (“ILM”) engine 20 communicatively coupled with the ECI tool 16 via an ILM/ECI repository connector 24; a plurality of record side management modules 28 communicatively coupled with the ILM engine 20 and with the ECI repository 20 via an ILM management interface 32; and a configuration repository 36 communicatively coupled with the ECI tool 16 via a plurality of object side management modules 40.

The object side management modules 40 include: a record registration module 44 for initiating and controlling a record registration process for registering objects stored in the repositories 12 with the ILM engine 20; a legal hold module 46 for initiating and controlling a legal hold process; and a spoliation detection module 48 for initiating a record spoliation detection process for keeping records corresponding with objects that have been destroyed. The record side management modules 50 include: a record disposition module 52 for initiating and controlling a record disposition process; an unregister module 54 for initiating and controlling an unregister process; and a lifecycle transition module 56 for initiating a lifecycle transition process.

Each of the content repositories 12 stores one or more objects. Each object may include a document or other content stored in a content repository 12. Each object may be associated with a document class (also referred to as item class or item type) generally describing the type of object (e.g., an invoice, a legal brief, an e-mail, etc.), and describing the object attributes (e.g., account number, date, customer name, etc.). In one embodiment, each object is stored in one of the repositories along with object attributes (e.g., metadata) describing the object. Also, in an embodiment, the objects may be stored in structures in the content repositories wherein each structure corresponds with a particular document class. A “record” is an object stored in the ILM engine 20. In an embodiment, each record is part of an associated record class, which describes the type of record (e.g., invoice, box, case file, matter file, etc.), its record attributes (e.g., account number, lifecycle date, customer name, case file type, etc.), and any special record handling instructions. As further explained below, each of the objects may or may not be registered with the ILM engine 20 during any particular time period. Each record points to a corresponding object in a content repository.

With the records management system 10, an authorized user can use the single ILM engine 20 to apply a uniform set of records management control functions to all records regardless of which of the repositories 12 the objects may be stored in. In one embodiment, the ECI tool 16 may be implemented by a commercially available ECI tool such as the Information Integrator Content Edition available from IBM Corporation, or the Interchange Suite available from Context Media Corporation. The ECI tool 16 provides for accessing the various content repositories 12 in order to perform object management functions including searching for objects, adding objects, modifying object contents, deleting objects, changing security, and updating object metadata. The ECI tool 16 is operative to transform the native API's of each of the content repositories 12 into a single uniform and abstract API that may be used by applications (e.g., ECI search tool applications, ECI web client, etc.) accessing the ECI tool 16 for the purpose of initiating record management actions and object management functions across all of the content repositories 12.

The ILM engine 20 is operative to perform record management functions including storing record registrations (or “records”); applying lifecycle rules to the records; issuing records disposition actions; and providing audit trails. Each record stored in the ILM engine 20 points to a corresponding registered object in one of the content repositories 12. In one embodiment, the ILM engine 20 may be implemented by a commercially available ILM engine such as Records Manager™ available from IBM Corporation or FileNet™ Records Manager.

Each of the objects registered with the ILM engine 20 may be managed in accordance with a file plan that may be stored in the ILM engine 20. A file plan refers generally to a policy, process, or practice used to manage records (and the corresponding objects) up to the time that the records (and the corresponding objects) are finally dispositioned. In one embodiment, the ILM engine 20 stores a hierarchical classification tree called a “file plan.” In this embodiment, each record is inserted into the file plan, and the location of the record in the file plan may determine the lifecycle of the object corresponding with the record. The ILM engine 20 also manages record classes. A “record class” is similar to a document class in a content repository. A “record class” generally defines a business object that can exist in multiple media formats. In one embodiment, each record class is defined by an authorized user and stored in the ILM engine. As an example, a contract object (i.e., an object that constitutes a legal contract) may be stored on paper, microfilm, in an electronic Word document, a PDF document and in an XML format and stored in different content repositories 12, all at the same time, but all of these objects must abide by the same retention schedule.

As explained below, the object side modules 40 are operative to initiate and control records management actions including records registration processes (see module 44), legal hold processes (see module 46), and spoliation detection processes (see module 48). As explained below, in one embodiment, the object side modules may be implemented as computer readable instructions, residing at or executed by, a processing engine associated with the ECI tool. The object side modules 40 provide for passing messages between the ECI tool 16, configuration repository 36, ILM engine 20 and repositories 12. In one embodiment, each of the object side modules 40 may be implemented by specially configuring a commercially available message queuing module such as MQ Series, Java Messaging Service, and MSMQ. In another embodiment, the object side modules may be implemented by configuring a message queuing layer built into the ECI tool.

The record side modules 28 are operative to initiate and control records management actions including lifecycle transition processes (see module 56), unregister processes (see module 54), and record disposition processes (see module 52). As explained below, in one embodiment, the object side modules may be implemented as computer readable instructions, residing at or executed by, a processing engine associated with the ILM engine. The record side modules 28 provide for passing messages between the ILM engine 20, ECI tool 16, configuration repository 36, and repositories 12. In a preferred embodiment, the record side modules 28 communicate directly with the API of the ECI tool 16. In an alternative embodiment, each of the record side modules 28 may be implemented by specially configuring a commercially available message queuing module such as MQ Series, Java Messaging Service, and MSMQ. In another embodiment, the record side modules may be implemented by configuring a message queuing layer built into the ECI tool.

As mentioned, the ILM engine 20 communicates with the ECI tool 16 via the ILM/ECI repository connector 24, and also via the record side management modules 28 which are connected between the ECI tool 16 and the ILM engine 20 via the ILM management interface 28. The ECI repository connector 24 allows the ECI tool 16 to interact with the ILM engine 20 as though the ILM engine 20 were a regular content repository. The ECI tool 16 accesses the ILM engine 20 via the ECI repository connector when the ECI tool 16 initiates a search across the different repositories 12.

The ILM management interface 28 allows the ILM engine 20 to initiate record management actions against the objects stored in the different content repositories 12. Record management actions initiated by the ILM engine 20 via the ILM management interface 28 are controlled by the record side management modules as further explained below. The ILM management interface 28 also provides for passing repository specific information that the ILM engine 20 may require such as information identifying content repository users and user groups. User and group information may be extracted from the content repositories 12, passed through the ECI tool 16, and used in the ILM engine 20.

The configuration repository 36 is a business rules and configuration tool that stores information necessary for performing records management actions. The configuration repository 36 contains information for registering objects in the content repositories 12 by creating corresponding records in the ILM engine 20. The configuration repository 36 provides a mapping between object information (e.g., the types of objects and locations of objects stored in different repositories) and record management information (e.g., record class, methods for registering and unregistering, lifecycle transitions, disposition, etc). An important feature of records management is that there is no single process that is “correct” from a business perspective, which means that a computer system that processes records for an organization must be flexible enough to address the various ways in which a user or company may wish to manage records.

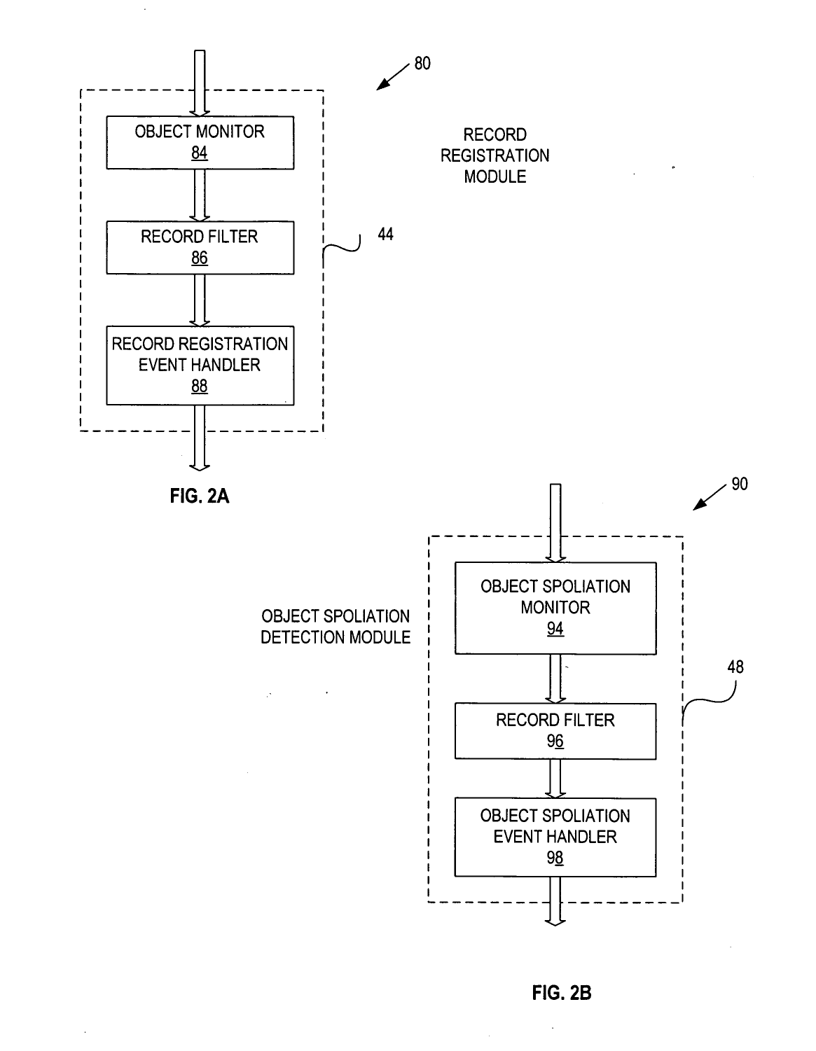

FIG. 2A shows a schematic block diagram generally illustrating one embodiment at 80 of the record registration module 44 (FIG. 1). In the depicted embodiment, the record registration module 44 includes: an object monitor 84 for monitoring the occurrence an object event (e.g., addition of new objects, updates of object metadata, and object deletions); a record filter 86 for filtering the object events detected by the object monitor based on selected criteria; and a record registration event handler 88 for initiating and controlling a record registration process as further described below.

The object monitor 84 monitors the arrival of new object events and passes object event messages containing information relevant to the object events to the record filter 86. The information contained in the object event messages may include a reference to a corresponding object using an ECI reference name, object metadata, content repository information, and document format information. In varying embodiments of the present invention, the object monitor 84 may be implemented as a directory monitor, a query monitor, a log monitor, an API monitor or a database monitor. If the object monitor 84 is implemented as a directory monitor, the record monitor 84 is operative to monitor one or more locations in a content repository (such as a folder or directory), and to send a message to the record filter 86 upon detection of a record event. If the object monitor 84 is implemented as a query monitor, the record monitor 84 is operative to execute a query on a content repository 12, and to send a message to the record filter 86 indicating the result of the query. If the object monitor 84 is implemented as a log monitor, the record monitor 84 is operative to monitor a specific log file in a content repository 12, and to send a message to the record filter 86 indicating when a new transaction is inserted into the specific log file. If the object monitor 84 is implemented as an API monitor, the record monitor 84 is operative to communicate with the native API of one of the content repositories 12, and to send a message to the record filter 86 indicating when an API hook is called by the content repository 12 for operations including adding, modifying and deleting objects. If the object monitor 84 is implemented as a database monitor, the record monitor 84 is operative to determine when a transaction matching selected database trigger parameters is met, and to send a message to the record filter 86 indicating the occurrence of such a transaction. In one embodiment, the object monitor resides in the ECI tool 16 (FIG. 1). In another embodiment, the object monitor may reside in one or more of the content repositories 12 (FIG. 1).

The record filter 86 is operative to filter record messages before the event handler 88 is called. A message may be filtered on all metadata fields included in the message and full text analysis of the body of the document. The purpose of the record filter is to screen out certain types of record events that are not of interest. In one embodiment, the record filter resides in the ECI tool 16 (FIG. 1). The record registration event handler 88 processes the filtered object messages and initiates and controls the record registration process.

As an example, the object monitor 84 may detect a new object (e.g., an invoice) in RESPOSITORY_2 (FIG. 1), and unless the filter 86 determines that this new object should not be registered, the record registration event handler 88 is invoked to initiate and control a record registration process for registering a record in the ILM engine pointing to the new object. The record registration event handler 88 passes messages to the ILM engine 20 (FIG. 1), the messages carrying: document class information indicating the type of the new object (i.e., an invoice); repository identification information indicating the location of the new object (i.e., RESPOSITORY_2); record class attributes; and an object action identifier (i.e., new object added to RESPOSITORY_2).

FIG. 2B shows a schematic block diagram generally illustrating one embodiment at 90 of the object spoliation detection module 48 (FIG. 1). Similar to the record registration module shown in FIG. 2A, in the depicted embodiment, the record registration module 44 includes: an object monitor 84 for monitoring the occurrence of object deletions; a record filter 86 for filtering the object events detected by the object monitor based on selected criteria; and a record registration event handler 88 for initiating and controlling a record spoliation detection process as further described below. As will be understood based on the above description, the elements 94, 96 and 98 may be implemented in a manner similar to the elements 84, 86 and 88 shown in FIG. 2A.

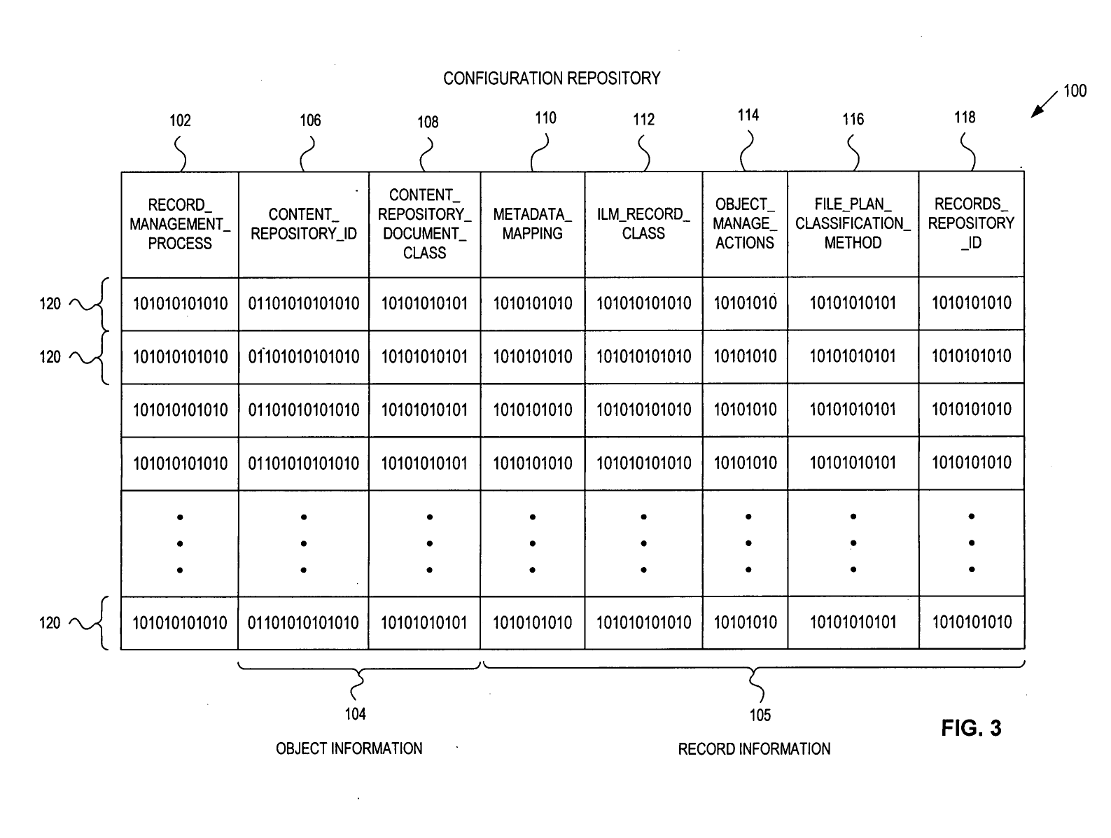

FIG. 3 is a table diagram generally illustrating information at 100 stored in the configuration repository 36 (FIG. 1). The configuration repository provides a mapping between object information 104 and record management information 105 for each of a plurality of record management actions 102. As further described below, the record management actions 102 include: registering records for selected objects; transitioning the lifecycle phases for selected records; disposing of selects records; updating metadata associated with selected records; updating security associated with selected records; unregistering records; detecting spoliation of objects; and placing objects on legal hold. Each of the rows in the table 100 constitutes business rule information 120 including information indicating how to perform the record management actions against the objects stored in the different content repositories.

The object information 104 includes: content repository ID information 106 identifying which of the content repositories 12 (FIG. 1) should be accessed in connection with a corresponding record management action; and content repository document class information 108 identifying the document class of an object involved in a corresponding management action. The record management information 105 includes: meta-data mapping information 110; ILM record class information 112; object management functions information 114; file plan classification method information 116; and records repository identification information 118.

The meta-data mapping information 110 provides a mapping between document class attributes and record class attributes for a corresponding record management action. The ILM record class information 112 describes the type of record (e.g., invoice, box, case file, matter file, etc.), its record attributes (e.g., account number, lifecycle date, customer name, case file type, etc.), and any special record handling instructions. The object management functions information 114 include: updating content repository object security data; updating content repository object metadata; updating record IDs; creating renditions; creating digital signatures; and other custom actions to be performed on objects in the content repositories. The file plan classification information 116 identifies where in the file plan a record should be inserted. Indeed, file plan classification is the process of determining where in the file plan a record should be inserted. The records repository identification information 118 indicates which of several records repositories should be used for storing each record.

As mentioned, the configuration repository 36 provides a mapping between object information (e.g., the types of objects and locations of objects stored in different repositories) and record information (e.g., type of records, methods for registering and unregistering, lifecycle phases, disposition, etc). The utility of the configuration repository is further explained below.

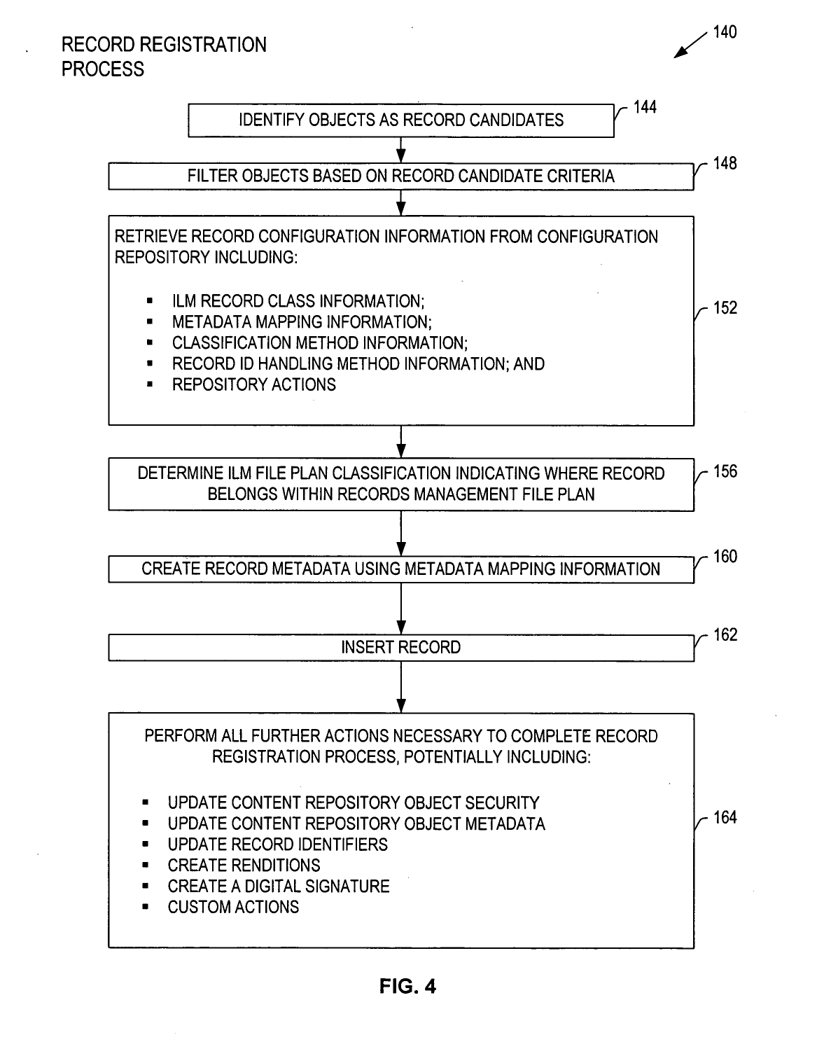

FIG. 4 shows a flow chart generally illustrating a record registration process at 140 for registering objects with the ILM engine 20 (FIG. 1) in accordance with the present invention. Upon registration, objects are placed under the control of the ILM engine. The records registration process is initiated and controlled by the record registration module 44 (FIG. 1). As explained below, the registration process requires knowledge of information including: the document class information 108 (FIG. 3) for each object to be registered; ILM record class information 112 (FIG. 3) for each object to be registered; classification method information for determining where to insert each record in the file plan (e.g., which retention location in the ILM engine); and object metadata for each object to be registered.

The record registration process 140 begins with a step 144 in which the object monitor 84 (FIG. 2A) of the record registration module 44 (FIG. 1) identifies new unregistered objects stored in one or more of the content repositories 12 (FIG. 1) as candidates for record registration, and passes a list of the candidate objects to the record filter 86 (FIG. 2A). From step 144, the process proceeds to step 148 in which the record filter 86 (FIG. 2A) filters the candidate objects based on selected criteria. The criteria for registering objects are determined based on the specific business rules associated with each new object. The results of the record filtering in step 148 are passed to the event handler 88 (FIG. 2A) of the record registration module.

From step 148, the process proceeds to step 152 which is a configuration repository lookup operation. In one embodiment of step 152, the event handler 88 (FIG. 2A) of the record registration module is invoked to access the configuration repository 36 (FIG. 1) for purposes of determining record registration information required to register each candidate object with the ILM engine 20 (FIG. 1). Step 152 is a configuration repository lookup that will return information that will be used to locate a new record (pointing to a new object) with in the file plan stored in the ILM engine 20 (FIG. 1). As mentioned, the position of the record in the file plan can be used to determine a file plan location for the new registered object. The record registration information includes: ILM record class information 112 (FIG. 3); metadata mapping information 110 (FIG. 3) identifying a mapping between content repository document class metadata elements and ILM record class metadata elements for each candidate object; classification method information 116 (FIG. 3); record ID handling method information; and object management actions 114 (FIG. 3).

Based on the record's business rules 120 (FIG. 3), the event handler 88 (FIG. 2) of the record registration module will look up what its record registration actions should be (e.g., changing security attributes, updating metadata, etc.). In varying embodiment of the present invention, the event handler may access the configuration repository 36 (FIG. 1) in accordance with any of a plurality of different lookup methods including: lookup by content repository; lookup by document class; lookup by content repository and document class; lookup by content repository and document class and metadata element; and lookup by metadata element.

The metadata mapping information 110 (FIG. 3) allows for several different mapping methods including: (1) fixed method (i.e., the record class is set a specified value for each configuration database lookup); (2) concatenated method (i.e., allowing for multiple document class metadata attributes to be concatenated together to create a record class attribute, including the concatenating of metadata fields and fixed fields together); (3) attribute method (i.e., allowing a specific content repository's metadata to be mapped to an ILM's record class metadata); (4) external method (i.e., using an external system to retrieve a value such as by a database lookup); and (5) folder method (i.e., mapping specific values of the folder's metadata fields to the record class).

From step 152, the process proceeds to step 156 in which the event handler 88 (FIG. 2A) of the record registration module determines an ILM record classification indicating where the new record belongs within the records management file plan in the ILM engine 20 (FIG. 1). In step 156, a new record can be classified within the records management file plan in accordance with one of the following methods: (1) fixed method (i.e., each record is classified to a fixed particular path within the file plan); (2) auto-classify method (i.e., an automatic classification feature is invoked to select a file plan path for the new record); (3) manual method (i.e., a metadata field is specified in the record containing the record's file plan path); (4) external method (i.e., an external tool is used to generate the file plan path); and (5) folder method (i.e., uses the value of a specific folder metadata selection the objects classification).

From step 156, the process proceeds to step 160 in which the event handler 88 (FIG. 2A) of the record registration module creates record attributes using the metadata mapping information 110 (FIG. 3). In one embodiment, the record ID from the ILM is inserted into the metadata of the object in the content repository. The record ID is a unique identifier used by the ILM engine 20 (FIG. 1) to identify a registered object. In another embodiment, the record ID from the ILM is inserted into a separate database. In yet another embodiment, the record ID from the ILM is thrown away.

From step 160, the process proceeds to step 162 in which the event handler 88 (FIG. 2A) inserts a record into the ILM engine 20 (FIG. 1) in the appropriate place in the file plan as determined in step 156. In one embodiment, the classification of the record is known and will be specified during insertion. In another embodiment, the classification of the record is unknown and will rely on the auto-classification method of the ILM.

From step 162, the process proceeds to step 164 in which the event handler 88 (FIG. 2A) performs all further actions necessary to complete the record registration process, including: updating content repository object security characteristics; updating content repository object metadata; updating record identifiers (stored with the objects in the content repositories); creating renditions; creating digital signatures; and performing custom actions. These actions can generally be processed in any order, and the order may be defined by a user. In one embodiment, all of these actions are performed on content repositories 12 (FIG. 1) by the record registration module 44 (FIG. 1) via the uniform API of the ECI tool 16 (FIG. 1).

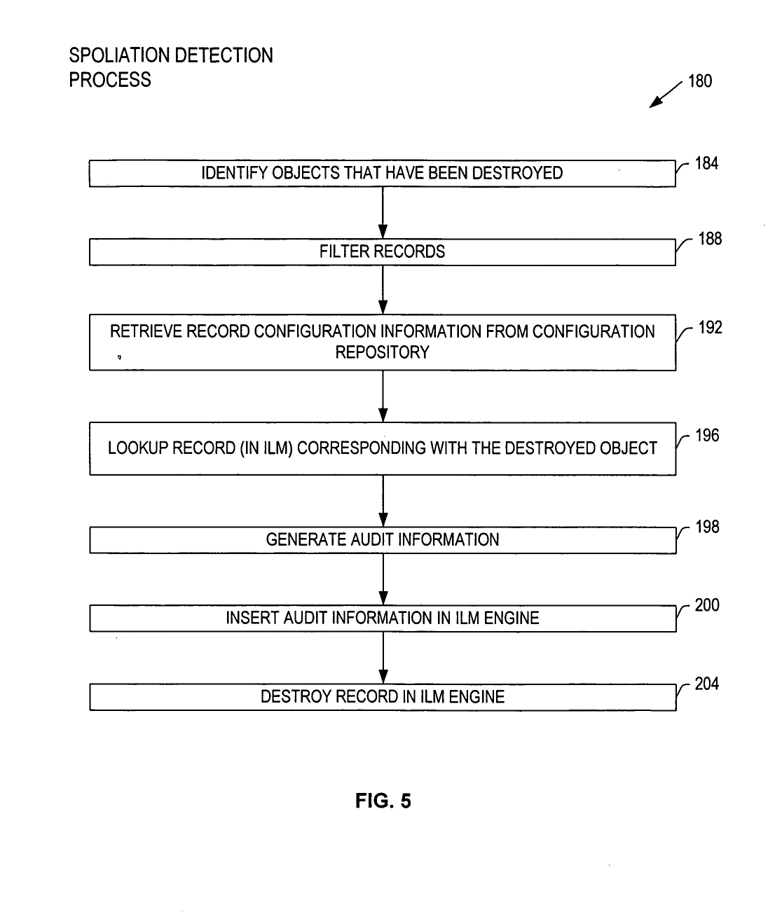

FIG. 5 shows a flow chart generally illustrating a records spoliation detection process 180, which is performed by the spoliation detection module 48 (FIG. 1) in accordance with the present invention. The records spoliation detection process 180 addresses the problem that in the normal course of business, objects in a content repository are destroyed outside of their lifecycle by means other than the ILM engine 20 (FIG. 1). The fact that such destruction happens often cannot be helped, but it is best to identify when such events have happened, and provide audit information reflecting the occurrence of the event. The records spoliation detection process 180 identifies records associated with destroyed objects, and updates the records management system appropriately.

The records spoliation detection process 180 begins with a step 184 in which the object spoliation monitor 94 (FIG. 2B) of the spoliation detection module 48 (FIG. 1) identifies registered objects stored in the content repositories that have been destroyed. In step 188, the record filter 96 (FIG. 2B) then determines whether or not the identified destroyed object should be audited. As an example, deletion of objects by the ILM engine 20 or deletion of objects that are not under ILM control may not need to be audited.

In step 192, the object spoliation event handler 98 (FIG. 2B) is invoked, and it retrieves record configuration information from the configuration repository 36 (FIG. 1). The object spoliation event handler 98 performs a lookup in the configuration repository to access the business rules that it needs to use in order to audit the deleted object. Based on the record's business rules 120 (FIG. 3), the object spoliation event handler will look up what its records actions should be. In varying embodiment of the present invention, the event handler may access the configuration repository 36 (FIG. 1) in accordance with any of a plurality of different lookup methods including: lookup by content repository; lookup by document class; lookup by content repository and document class; lookup by content repository and document class and metadata element; and lookup by metadata element.

From step 192, the process proceeds to step 196 in which the object spoliation event handler 98 (FIG. 2B) accesses the record in the ILM engine 20 that points to the destroyed object. In step 198, the object spoliation event handler generates audit information (e.g., an audit log entry) indicating that the object identified by the record accessed in step 192 has been destroyed. In step 200, the object spoliation event handler inserts the audit information into the ILM engine 20 (FIG. 1). In step 204, the record accessed in step 192 is itself destroyed.

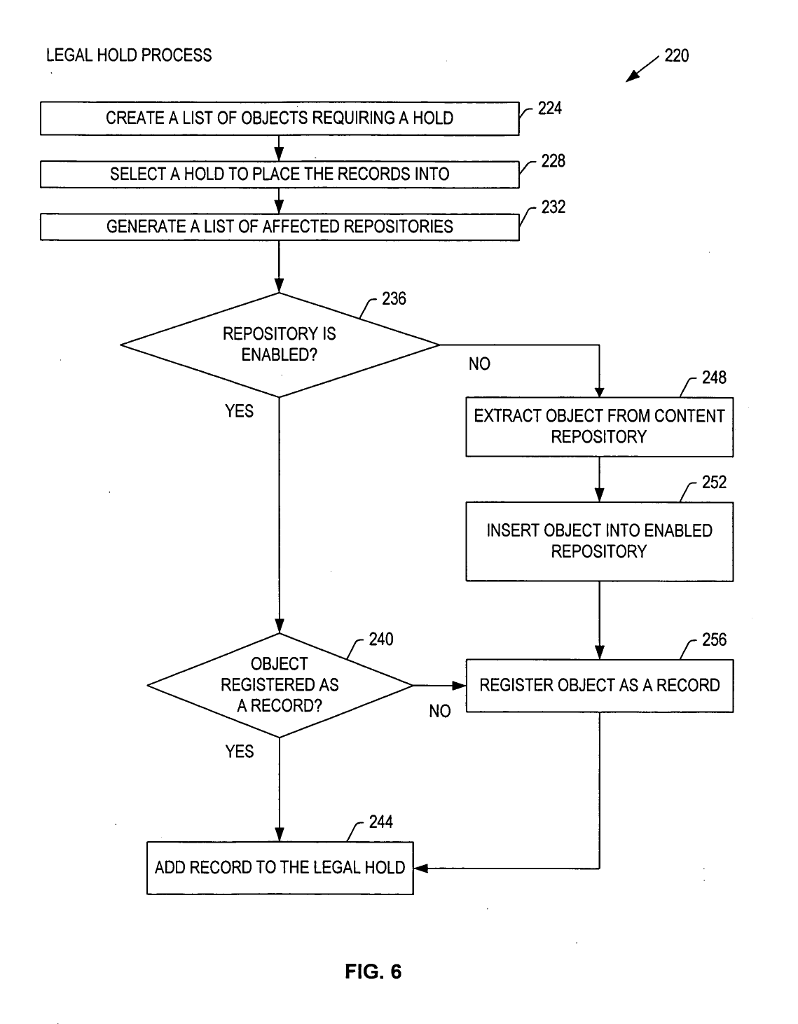

FIG. 6 shows a flow chart generally illustrating a legal hold process at 220 in accordance with the present invention. The legal hold process is performed by the legal hold module 46 (FIG. 1), which is preferably implemented as an event handler. The legal hold process 220 leverages the basic feature of the present invention to provide a method to search all registered and unregistered objects in the content repositories 12 (FIG. 1). Once objects are selected, they can be redacted by the system user until such time that the object set is finalized. With this finalized set of objects, the user can select from a series of records actions.

The legal hold process 220 begins with a step 224 in which the legal hold module 46 (FIG. 1) creates a list of objects requiring a hold. The list of objects requiring a hold can be accomplished using either a query method or a virtual repository method. For example, an organization may receive a court order requiring production of documents satisfying certain specified criteria. In accordance with a query method, an authorized user of the records management system 10 (FIG. 1) could then use the ECI tool 16 (FIG. 1) to perform a search across all of the content repositories 12 (FIG. 1) to locate objects satisfying the specified criteria, which results in a “view” of documents to be put on hold. In general, all of the objects subject to the legal hold should be retained by the organization. In one embodiment, the ECI tool 16 (FIG. 1) includes a search interface allowing the user to initiate step 224 of the legal hold process 200. In another embodiment, the list of objects requiring a hold can be accomplished using a virtual repository method. The virtual repository method allows a user to use the standard virtual repository features of the ECI tool 16 (FIG. 1) by which the user may have created one object at a time or using a series of queries.

Upon initiation of the legal hold process 200, before or after step 224, the legal hold module 46 (FIG. 1) is invoked to create the list of objects requiring a hold. From step 224, the process proceeds to step 228 in which the legal hold module 46 (FIG. 1) selects a hold in which to place records (associated with the objects determined in step 224) to be subject to a legal hold. In one embodiment, an ILM hold name is selected. In one embodiment, a legal hold is a suspension in the ILM engine 20 (FIG. 1) into which records may be inserted. Once a record has been inserted into the legal hold, all lifecycle rules for the record are suspended until the hold is removed.

In step 232, the legal hold module determines a list of affected content repositories 12 (FIG. 1), including all repositories containing objects which are subject to the legal hold. In step 236, the legal hold module determines whether a first one of the affected content repositories is enabled (i.e., operative to apply a legal hold). As mentioned above, each of the content repositories may be different. A content repository is not operative to apply a legal hold for purposes of the legal hold process if it does not allow for setting security primitives, or if it enforces a strict retention period that cannot be overridden. If it is determined at 236 that the content repository is enabled (i.e., operative to apply a legal hold), then the process proceeds to 240 in which legal hold module 46 (FIG. 1) determines whether or not the current object is registered as a record. If it is determined at 240 that the current object is registered as a record, then the process proceeds to step 244 in which the legal hold module 46 (FIG. 1) adds the current record pointing to the current object to the legal hold.

If it is determined at 236 that the content repository is not enabled (i.e., not operative to apply a legal hold), then the process proceeds to step 248 in which the legal hold module 46 (FIG. 1) extracts the current object from its original content repository, then to step 252 in which the legal hold module inserts the current object into an enabled content repository (i.e., a repository operative to apply a legal hold), and then to step 256 in which the legal hold module initiates the record registration process (see process 140 in FIG. 4) to register the current object as a record. From step 256, the process proceeds to step 244 to add the record to the legal hold as described above. Also, if it is determined at 40 that the current object is not registered as a record, then the process proceeds to step 256 to register the object as a record before proceeding to step 244 in which the record is added to the legal hold. In one embodiment, steps 236 to 244 are repeated for each object in the list created in step 244. In an alternative embodiment, steps 236 to 244 could be performed on a number of objects in parallel.

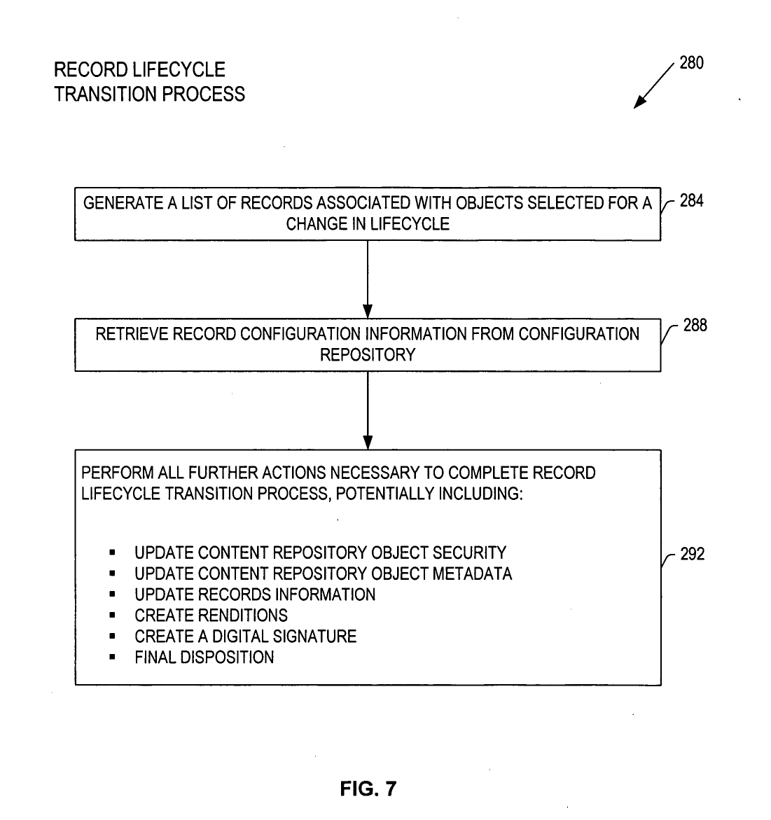

FIG. 7 shows a flow chart generally illustrating a record lifecycle transition process at 280 in accordance with the present invention. The record lifecycle transition process 280 is performed by the lifecycle transition module 56 (FIG. 1). An object that is registered as a record has a “lifecycle” associated with it. Generally most objects do not have a complex lifecycle. The lifecycle usually consists of a couple of phases like “active” and “dormant.” However, some business rules require that objects migrate between a series of different lifecycle phases. In some cases these lifecycle phase have specific actions that must be taken against the object stored within the content repository. As an example, an object might have its permissions changes has it progresses through its life cycle. The process 280 provides for management of objects that have been previously registered as a record and need to have a change in the object's “lifecycle”. This change in lifecycle may include updating an objects security permissions/Access Control Lists (“ACL”), changing its existence in a particular repository, triggering a migration of the object to a new media, or destruction of the object.

The process 280 begins with a step 284 in which the lifecycle transition module 56 (FIG. 1) generates a list of records associated with objects selected for a change in lifecycle. In a preferred embodiment, the lifecycle transition module 56 (FIG. 1) is a handler that is invoked by the process. In step 288, the lifecycle transition module 56 (FIG. 1) performs a lookup to retrieve record configuration information from the record configuration repository 36 (FIG. 1). The lookup in step 288 results in the retrieval of: business rules information 120 (FIG. 3) needed to affect the transition of the object to the next phase of its lifecycle; and object management action information 114 (FIG. 3) needed to determine what lifecycle actions should be taken. In varying embodiments of the present invention, the lifecycle transition module 56 (FIG. 1) may access the configuration repository 36 (FIG. 1) during step 288 in accordance with any of a plurality of different lookup methods including: lookup by content repository; lookup by document class; lookup by content repository and document class; lookup by content repository and document class and metadata element; and lookup by metadata element.

From step 288, the process proceeds to step 292 in which the lifecycle transition module 56 (FIG. 1) performs further actions specified by the business rules 120 (FIG. 3). Some examples of lifecycle transition actions that may be specified include: updating content repository object security data; updating content repository object metadata; creating renditions; creating digital signatures; deleting extra copies of the object; moving the objects between content repositories; changing final disposition states; and other custom actions to be performed on objects in the content repositories.

The records disposition process in the present invention is the process by which objects have their “final” disposition handled. This might include destroying the object, extracting and transferring the object to another legal authority, or reviewing the object to an update of the object's vital records status or security classification. There are a number of disposition states that are addressed in the present invention, including deletion, expunge, destruction, accession, unregistering and exportation.

The deletion process relies on the basic deletion capability of a content repository 12 (FIG. 1). This deletion capability generally does not meet the needs of “scrubbing” the information off of the underlying storage media. The expunge process relies on an advanced deletion method that “scrubs” the media a sufficient number of times such that the original data is not recoverable. The accession process is the action of extracting the object from the underlying content repository, packaging it up, and passing it to another legal entity to be responsible for it. The unregister process is the action of unregistering an object from the ILM. The exportation process is the action of removing an object from one content repository 12 (FIG. 1) and moving to another content repository within the same legal scope of control. For most purposes of the final disposition, this can be treated as though it were just another phase of the records lifecycle albeit the last one.

Although the present invention has been described in considerable detail with reference to certain preferred versions thereof, other versions are possible. Therefore, the spirit and scope of the appended claims should not be limited to the description of the preferred versions contained herein.

What is claimed is:

1. A record management system for managing records corresponding with objects stored in a plurality of content repositories each being communicatively coupled with an enterprise content integration (“ECI”) tool operative access the content repositories in order to perform object management functions, and an information lifecycle management (“ILM”) engine operative to store and manipulate the records, comprising:
a configuration repository providing a mapping between object information and record management information for each of a plurality of record management actions;
at least one object side record management module communicatively coupled with the ECI tool, the ILM engine and the configuration repository, and being responsive to object events, and operative to initiate and control at least one of the record management action based on the mapping provided by the configuration repository;
at least one record side record management module communicatively coupled with the ILM engine and the configuration repository, and being responsive to record events, and operative to initiate and control at least one of the record management actions based on the mapping provided by the configuration repository.

2. A record management system as recited in claim 1 wherein the object information includes document class information identifying the document class of an object involved in a corresponding management action.

3. A record management system as recited in claim 1 wherein the object information includes content repository identification information identifying which if the content repositories should be accessed in connection with a corresponding record management action.

4. A record management system as recited in claim 1 wherein the record management information includes record management action information indicating how to perform record management actions against the objects stored in the different content repositories, the actions including:
registering records for selected objects;
transitioning lifecycle phases for selected records;
dispositioning selects records;
updating metadata associated with selected records; and
updating security associated with selected records.

5. A record management system as recited in claim 1 wherein the record management information includes meta-data mapping information providing a mapping between document classes and record classes for a corresponding record management action.

6. A record management system as recited in claim 1 wherein the record management information includes file plan classification information indicating where in the file plan a record should be inserted.

7. A record management system as recited in claim 1 wherein the record management information includes record class information indicating a type of record and record attributes.

8. A record management system as recited in claim 1 wherein the object management functions performed by the ECI tool include searching for objects, adding objects, modifying objects, deleting objects, changing security attributes associated with objects, and updating metadata associated with objects.

9. A record management system as recited in claim 1 wherein the object side record management module is a record registration module operative to perform a record registration process, and the object events include the detection of a new unregistered object to be registered in accordance with the record registration process.

10. A record management system as recited in claim 1 wherein the object side record management module is a legal hold module operative to perform a legal hold process, and the object events include the identification of one or more objects to be placed on legal hold in accordance with the legal hold process.

11. A record management system as recited in claim 1 wherein the object side record management module is a spoliation detection module operative to perform a spoliation detection process, and the object events include the identification of one or more objects that have been destroyed.

12. A record management system as recited in claim 1 wherein the record side record management module is a lifecycle transition module operative to perform a lifecycle transition process, and the record events include the identification of one or more records which have been identified for a change in lifecycle.

13. A record management system as recited in claim 1 wherein each of the content repositories has a different native application programming interface (“API's”), and wherein the ECI tool is operative to transform the native API's of each of the content repositories into a uniform API.

14. A record management system as recited in claim 1 wherein each of the registered objects has an associated lifecycle managed by the ILM engine, and wherein the record management actions include transitioning the lifecycle of selected registered objects.

15. A record management system as recited in claim 3 wherein ECI tool includes a classification method, wherein records are inserted into corresponding locations in the file plan, and wherein the location of each record in the file plan dictates at least in part the lifecycle of the corresponding registered object.

16. A record management system as recited in claim 1 wherein the record management module is a record registration module operative to perform the steps of:
identifying an object to be registered as a new record;
retrieving record configuration information from the configuration repository in order to configure the new record;
determining a record class indicating a type of record and record attributes;
retrieving classification method information indicating a method for locating the new record in the file plan;
creating record metadata using metadata mapping information; and
inserting the new record into the determined location in file plan in the ILM engine.

17. A record management system as recited in claim 16 wherein the record registration module is operative to perform the further steps of:
updating metadata associated with the object; and
changing security attributes associated with the object;
creating renditions; and
creating digital signatures.

18. A record management system as recited in claim 1 wherein the record management module is a spoliation detection module operative to perform the steps of:
identifying an object that has been destroyed;
retrieving record configuration information associated with the identified object from the configuration repository; and
updating the ILM engine to include audit information indicating that the identified object has been destroyed.

19. A record management system as recited in claim 1 wherein the record management module is a legal hold module operative to perform the steps of:
selecting a hold;
identifying at least one content repository containing an identified object requiring a hold;
determining whether or not the identified content repository is enabled to provide a legal hold;
determining whether or not the identified object is registered in the ILM engine;
if the content repository is enabled and the identified object is registered, adding the record corresponding with the identified object to the hold.

20. A record management system as recited in claim 19 wherein the legal hold module is operative to perform the following steps if the content repository is not enabled to provide a legal hold:
extracting the identified object from the identified content repository;
inserting the identified object into a different content repository that is enabled to provide a legal hold;
registering the identified object as a record; and
adding the record to the legal hold.

21. A record management system as recited in claim 19 wherein, if the identified object is not registered, the legal hold module is operative to register the identified object as a record before adding the record to the hold.

22. A record management system as recited in claim 1 wherein the record management module is a lifecycle transition module operative to perform the steps of:
identifying at least one record associated with an object selected for a change in lifecycle;
retrieving record configuration information associated with the identified record from the configuration repository; and
performing at least one lifecycle transition action based on the record configuration information associated with the identified record.

23. A record management system as recited in claim 22 wherein the lifecycle transition action is selected from a group consisting of:
updating content repository object security information;
updating content repository object metadata;
updating records information;
creating renditions;
creating a digital signature; and
final disposition.

24. A record management system as recited in claim 1 wherein the object side management modules are operative to pass messages between the ECI tool, configuration repository, ILM engine and repositories.

25. A record management system as recited in claim 1 wherein the record management actions include storing records, applying lifecycle rules to the records, issuing records disposition actions for disposing of records, and providing audit trails for associated records.

26. A record management system as recited in claim 1 wherein at least one of the object side management modules includes:
an object event monitor for monitoring object events, and generating object event messages
an object event filter operative to filter the object event messages, and to provide filtered messages;
an object side event handler for receiving and processing the filtered messages, and being operative to perform one or more of the record management actions.

27. A record management system as recited in claim 26 wherein the object event monitor is a directory monitor operative to monitor one or more locations in a content repository, and to send a message to the record filter upon detection of a record event.

28. A record management system as recited in claim 26 wherein the monitor is a query monitor operative to execute a query on one of the content repositories, and to send a message to the record filter indicating the result of the query.

29. A record management system as recited in claim 26 wherein the monitor is a log monitor operative to monitor a specific log file in one of the content repositories, and to send a message to the record filter indicating when a new transaction is inserted into the specific log file.

30. A record management system as recited in claim 26 wherein the monitor is an API monitor operative to communicate with the native API of one of the content repositories, and to send a message to the record filter indicating when an API is called by the content repository for operations including adding, modifying and deleting objects.

31. A record management system as recited in claim 26 wherein the monitor is a database monitor operative to determine when a transaction matching selected database trigger parameters is met, and to send a message to the record filter indicating when a transaction matching the database trigger parameters is met.

32. A record management method for managing records corresponding with objects stored in a plurality of content repositories each being communicatively coupled with an enterprise content integration (“ECI”) tool operative access the content repositories in order to perform object management functions, and an information lifecycle management (“ILM”) engine operative to store and manipulate the records, comprising the steps of:
creating a configuration repository providing a mapping between object information and record management information for each of a plurality of record management actions;
instantiating at least one object side record management module communicatively coupled with the ECI tool, the ILM engine and the configuration repository, and being responsive to object events, and operative to initiate and control at least one of the record management actions based on the mapping provided by the configuration repository; and
instantiating at least one record side record management module communicatively coupled with the ILM engine and the configuration repository, and being responsive to record events, and operative to initiate and control at least one of the record management actions based on the mapping provided by the configuration repository.

33. A record management method as recited in claim 32 wherein the object information includes document class information identifying the document class of an object involved in a corresponding management action.

34. A record management method as recited in claim 32 wherein the object information includes content repository identification information identifying which if the content repositories should be accessed in connection with a corresponding record management action.

35. A record management method as recited in claim 32 wherein the record management information includes record management action information indicating how to perform record management actions against the objects stored in the different content repositories, the actions including:
registering records for selected objects;
transitioning lifecycle phases for selected records;
dispositioning selects records;
updating metadata associated with selected records; and
updating security associated with selected records.

36. A record management method as recited in claim 32 wherein the record management information includes meta-data mapping information providing a mapping between document classes and record classes for a corresponding record management action.

37. A record management method as recited in claim 32 wherein the record management information includes file plan classification information indicating where in the file plan a record should be inserted.

38. A record management method as recited in claim 32 wherein the record management information includes record class information indicating a type of record and record attributes.

39. A record management method as recited in claim 32 wherein the object side record management module is a record registration module operative to perform a record registration process, and the object events include the detection of a new unregistered object to be registered in accordance with the record registration process.

40. A record management method as recited in claim 32 wherein the object side record management module is a legal hold module operative to perform a legal hold process, and the object events include the identification of one or more objects to be placed on legal hold in accordance with the legal hold process.

41. A record management method as recited in claim 32 wherein the object side record management module is a spoliation detection module operative to perform a spoliation detection process, and the object events include the identification of one or more objects that have been destroyed.

42. A record management method as recited in claim 32 wherein the record side record management module is a lifecycle transition module operative to perform a lifecycle transition process, and the record events include the identification of one or more records which have been identified for a change in lifecycle.

43. A record management method as recited in claim 32 wherein each of the content repositories has a different native application programming interface (“API's”), and wherein the ECI tool is operative to transform the native API's of each of the content repositories into a uniform API.

44. A record management method as recited in claim 32 wherein each of the registered objects has an associated lifecycle managed by the ILM engine, and wherein the record management actions include transitioning the lifecycle of selected registered objects.

45. A record management method as recited in claim 32 wherein the record management module is a record registration module operative to perform the steps of:
identifying an object to be registered as a new record;
retrieving record configuration information from the configuration repository in order to configure the new record;
determining a record class indicating a type of record and record attributes;
retrieving classification method information indicating a method for location the new record in the file plan;
creating record metadata using metadata mapping information; and
inserting the new record into the determined location in file plan in the ILM engine.

46. A record management method as recited in claim 45 wherein the record registration module is operative to perform the further steps of:
updating metadata associated with the object; and
changing security attributes associated with the object;
creating renditions; and
creating digital signatures.

47. A record management method as recited in claim 32 wherein the record management module is a spoliation detection module operative to perform the steps of:
identifying an object that has been destroyed;
retrieving record configuration information associated with the identified object from the configuration repository; and
updating the ILM engine to include audit information indicating that the identified object has been destroyed.

48. A record management method as recited in claim 32 wherein the record management module is a legal hold module operative to perform the steps of:
selecting a hold;
identifying at least one content repository containing an identified object requiring a hold;
determining whether or not the identified content repository is enabled to provide a legal hold;
determining whether or not the identified object is registered in the ILM engine;
if the content repository is enabled and the identified object is registered, adding the record corresponding with the identified object to the hold.

49. A record management method as recited in claim 48 wherein the legal hold module is further operative to perform the following steps if the content repository is not enabled to provide a legal hold:
extracting the identified object from the identified content repository;
inserting the identified object into a different content repository that is enabled to provide a legal hold;
registering the identified object as a record; and
adding the record to the legal hold.

50. A record management method as recited in claim 48 wherein, if the identified object is not registered, the legal hold module is operative to register the identified object as a record before adding the corresponding record to the hold.

51. A record management method as recited in claim 32 wherein the record management module is a lifecycle transition module operative to perform the steps of:
identifying at least one record associated with an object selected for a change in lifecycle;
retrieving record configuration information associated with the identified record from the configuration repository; and
performing at least one lifecycle transition action based on the record configuration information associated with the identified record.

52. A record management method as recited in claim 50 wherein the lifecycle transition action is selected from a group consisting of:
updating content repository object security information;
updating content repository object metadata;
updating records information;
creating renditions;
creating a digital signature; and
final disposition.

53. A record management method as recited in claim 32 wherein the object side management modules are operative to pass messages between the ECI tool, configuration repository, ILM engine and repositories.

54. A record management method as recited in claim 32 wherein the record management actions include storing records, applying lifecycle rules to the records, issuing records disposition actions for disposing of records, and providing audit trails for associated records.

55. A record management method as recited in claim 32 wherein at least one of the object side management modules performs the steps of:
monitoring object events;
generating object event messages indicating the occurrence of an object event;
filtering the object event messages;
processing the filtered messages; and
performing one or more of the record management actions based on the filtered messages.
